(19) United States
(12) Patent Application Publication
(10) Pub. No.: US 2011/0067090 A1
(43) Pub. Date: Mar. 17, 2011

(54) IMAGE DATA FORMING APPARATUS

(75) Inventor: Fumihito OSAKI, Tokyo (JP)

(73) Assignee: OKI DATA CORPORATION, Tokyo (JP)

(21) Appl. No.: 12/881,445

(22) Filed: Sep. 14, 2010

(30) Foreign Application Priority Data
Sep. 15, 2009 (JP) 2009-213602

(51) Int. Cl. H04L 9/32; G06F 7/04

(52) U.S. Cl. 726/4; 726/5

(57) ABSTRACT

An image data forming apparatus includes: an image data forming unit configured to form image data; a user authentication information forming unit configured to form user authentication information; a storage unit storing a program configured to be executed by a destination device to determine whether or not to permit outputting the image data from the destination device based on the user authentication information; an image file forming unit configured to form an image file including the image data, the user authentication information, and the program; and a communication control unit configured to transmit the image file to the destination device.

### CROSS REFERENCE TO RELATED APPLICATIONS

This application claims priority based on 35 USC 119 from prior Japanese Patent Application No. P2009-213602 filed on Sep. 15, 2009, entitled “IMAGE DATA FORMING APPARATUS”, the entire contents of which are incorporated herein by reference.

### BACKGROUND OF THE INVENTION

1. Field of the Invention

The present invention relates to an image data forming apparatus to form image data.

2. Description of Related Art

In a conventional technique (for example, see Japanese Patent Application Laid-Open No. 2005-14591, paragraphs 0069 to 0076 and FIG. 3), when a printer receives print data with user information as authentication information, the printer transmits the user information with an authentication request to a printer management server, the printer manager server performs an authentication to determine whether the user is qualified to print according to the user information, and the printer prints the print data when receiving an authentication notification from the printer management server. That is, the conventional technique can restrict printing of an unqualified user.

### SUMMARY OF THE INVENTION

However, the conventional technique requires an authentication-dedicated terminal such as the printer management server. In other words, only a computer or a printer that is connected to the printer management server via a communication line such as a network can restrict printing of an unqualified user according to the authentication information.

An aspect of the invention is an image data forming apparatus including:

an image data forming unit configured to form image data; a user authentication information forming unit configured to form user authentication information; a storage unit storing a program configured to be executed by a destination device to determine whether or not to permit outputting the image data from the destination device based on the user authentication information; an image file forming unit configured to form an image file including the image data, the user authentication information, and the program; and a communication control unit configured to transmit the image file to the destination device.

The aspect can restrict printing of an unqualified user even in an unconnected condition, via a communication line, to a printer management server that executes an authentication process.

### BRIEF DESCRIPTION OF THE DRAWINGS

FIG. 1 is a block diagram illustrating the configuration of an image data forming apparatus and a PC according to a first embodiment.

FIG. 2 is an explanatory diagram of the configuration of an image data forming system according to the first embodiment.

FIG. 3 is a flowchart illustrating an image data forming process according to the first embodiment.

FIG. 4 is an explanatory diagram of an operation panel unit used to set user authentication information according to the first embodiment.

FIG. 5 is a flowchart illustrating a process of inputting user authentication information according to the first embodiment.

FIGS. 6A and 6B are explanatory diagrams of the configuration of an authentication-print-program-applied image file according to the first embodiment.

FIGS. 7A and 7B are explanatory diagrams of an example of executing the authentication-print-program-applied image file according to the first embodiment.

FIG. 8 is a flowchart illustrating a process of executing the authentication-print-program-applied image file according to the first embodiment.

FIG. 9 is an explanatory diagram of the configuration of an image data forming system according to a modification of the first embodiment.

FIG. 10 is a flowchart illustrating an image data forming process according to a second embodiment.

FIG. 11 is an explanatory diagram of an operation panel unit used to set user authentication information and print restriction information according to the second embodiment.

FIG. 12 is a flowchart illustrating a process of inputting user authentication information and print restriction information according to the second embodiment.

FIGS. 13A and 13B are explanatory diagrams of the configuration of an authentication-print-program-applied image file according to the second embodiment.

FIGS. 14A, 14B and 14C are explanatory diagrams of an example of executing the authentication-print-program-applied image file according to the second embodiment.

FIG. 15 is a flowchart illustrating a process of executing the authentication-print-program-applied image file according to the second embodiment.

### DETAILED DESCRIPTION OF EMBODIMENTS

Descriptions are provided herein below for embodiments based on the drawings. In the respective drawings referenced herein, the same constituents are designated by the same reference numerals and duplicate explanation concerning the same constituents is omitted. All of the drawings are provided to illustrate the respective examples only.

### First Embodiment

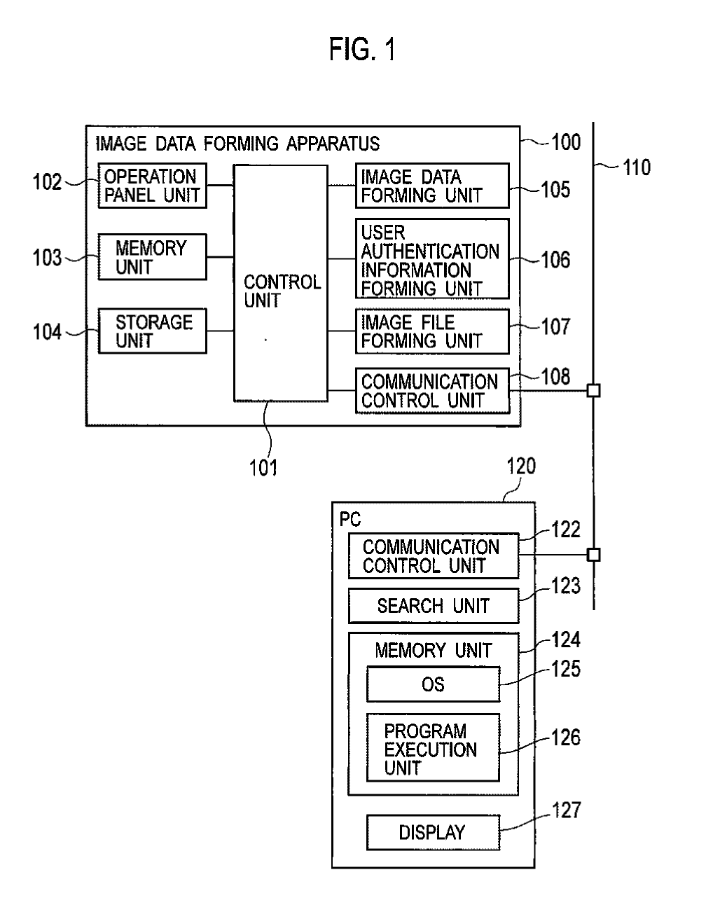

The configuration of a first embodiment will be explained by referring to FIGS. 1, 2, 4, 6A, 6B, 7A and 7B.

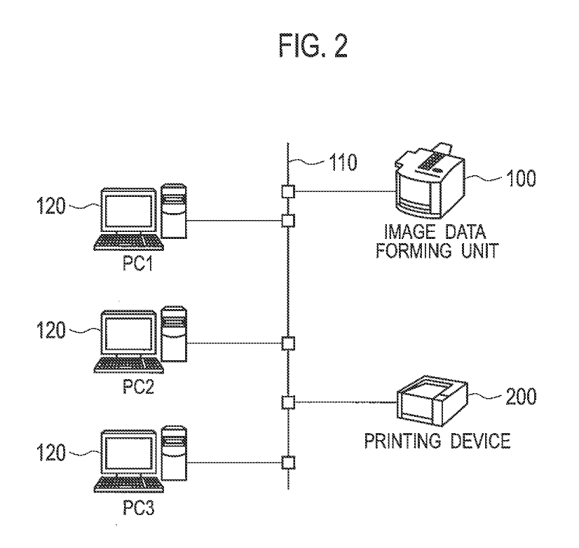

FIG. 2 is an explanatory diagram of an image data forming system according to the first embodiment.

In FIG. 2, the image data forming system includes image data forming apparatus 100, printing device 200 such as a printer, network 110, and personal computer (hereinafter, referred to as “PC”) 120. Image data forming apparatus 100 and printing device 200 are communicatably connected via network 110. Here, one or more PCs 120 are connected to network 110.

FIG. 1 is a block diagram illustrating the configuration of the image data forming apparatus and PC according to the first embodiment.

As shown in FIG. 1, image data forming apparatus 100 includes: control unit 101 configured to control the entire operation of the apparatus; operation panel unit 102 used to operate the image data forming apparatus 100; memory unit 103 configured to temporarily store data in progress; storage unit 104 configured to store a program or the like; image data forming unit 105 configured to form image data; user authentication information forming unit 106 configured to form user authentication information; image file forming unit 107 configured to form an image file in which an authentication print program is added; and communication control unit 108 configured to communicate with an external device.

Operation panel unit 102 includes: display means such as a liquid crystal display for displaying a device condition and a screen to guide operation by an operator; and input means such as an operation button and a touch panel for accepting input by the operator.

Memory unit 103 is a memory means such as a volatile memory or the like, and storage unit 104 is a memory means such as a nonvolatile memory, a magnetic disk, or the like.

Image data forming unit 105 forms digital image data from an image scanned (read) by an image scanning (reading) means (not shown) such as a scanner.

User authentication information forming unit 106 forms user authentication information composed of a user name and a password previously set by a user, which are used to identify the user, based on an input via operation panel unit 102.

Image file forming unit 107 forms an authentication-print-program-applied image file in which an authentication print program including user authentication information formed by user authentication information forming unit 106 is attached to the image data formed by image data forming unit 105. The configuration of the authentication-print-program-applied image file will be described later.

Communication control unit 108 controls transmission and reception of data such as an authentication-print-program-applied image file to and from PCs 120 and the like connected via network 110.

The entire operation of image data forming apparatus 100 having the above configuration is controlled by control unit 101 such as a central processing unit (CPU) serving as a computation means and a control means based on a control program (software) stored in storage unit 104.

Network 110 is a communication line that provides an environment in which image data forming apparatus 100 and an external device such as PC 120 can communicate with each other.

PC 120 includes: communication control unit 122 configured to transmit and receive image data to and from image data forming apparatus 100; search unit 123; memory unit 124 such as a memory; display means 127 such as a display; and an input means (not shown) such as a keyboard and a mouse. Memory unit 124 stores operating system (OS) 125 that is software for controlling the entire operation of the apparatus, and program execution unit 126. Operation of the entire PC 120 is controlled by a control unit (not shown) such as a central processing unit (CPU) serving as a computation means and a control means based on OS 125 stored in memory unit 124.

Further, the control unit of PC 120 is configured to execute an authentication print program of an authentication-print-program-applied image file received from image data forming apparatus 100.

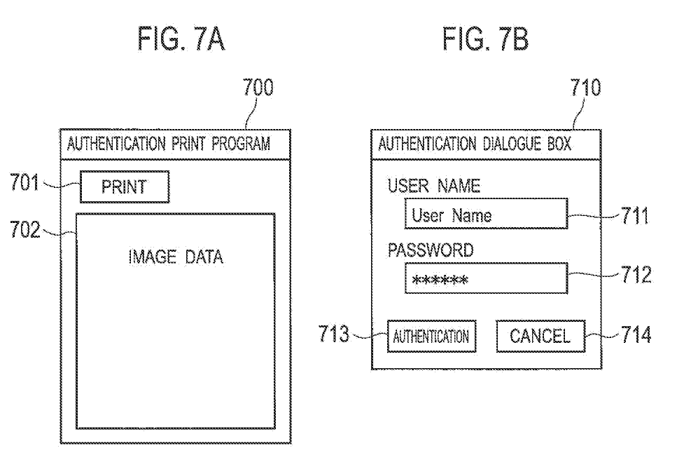

When a user clicks print button 701 (see FIG. 7A), search unit 123 (FIG. 1) of PC 120 searches authentication print program execution unit 126 from memory unit 124 of PC 120 and PC 120 executes the authentication print program. Note that authentication print program execution unit 126 is previously stored in memory unit 124.

FIG. 4 is an explanatory diagram of operation panel unit 102 used to set user authentication information according to the first embodiment.

In FIG. 4, operation panel unit 102 includes a liquid crystal display (LCD) panel 401 serving as a display means and operation units 402 to 408 serving as input means to accept an input operation to register user authentication information used to identify a user who is allowed to use the image data forming system. Note that LCD display panel 401 also includes a touch panel serving as an input means to accept the user's input operation.

LCD display panel 401 displays an authentication print setting screen for guiding an input operation to register user authentication information. This authentication print setting screen includes: user type setting unit 409 that allows selection of the type of user; user name registration unit 410 used to input the name of the user who is to be allowed to print; password registration unit 411 used to input a password of the user; add button 412 used to proceed to an additional registration to add authentication information of another user; and cancel button 413 used to cancel the additional registration of the authentication information. Note that when enter button 40b is pressed, the user name and the password that are input in the user name registration unit 410 and password registration unit 411 are registered as the authentication information.

FIGS. 6A and 6B are explanatory diagrams of the configuration of the authentication-print-program-applied image file according to the first embodiment. FIG. 6A illustrates the configuration of the authentication-print-program-applied image file and FIG. 6B illustrates the configuration of the authentication print program.

As shown in FIG. 6A, authentication-print-program-applied image file 600 formed by image data forming apparatus 100 includes authentication print program 601 and image data 602. Authentication-print-program-applied image file 600 is transmitted from image data forming apparatus 100 to PC 120 and executed in PC 120 serving as a destination.

Authentication print program 601 is software executed by the control unit of PC 120 and includes: user authentication information 611 composed of a user name and a password; comparison unit 612 which is a program for comparing a user name and a password input by a user of receiving PC 120 with the user name and password in user authentication information 611; print control unit 613 which is a program for controlling whether or not to print image data 602 according to a judgment result by comparison unit 612 of whether or not the user name and password input by the user in the receiving PC 120 correspond with the user name and password of user authentication information 611; and image display control unit 614 which is a program for displaying image data 602 on the display means as a preview screen, as shown in FIG. 6B, for example.

Note that image data 602 is image data formed by image data forming unit 105 of image data forming apparatus 100. Further, comparison unit 612, print control unit 613, and image display control unit 614 are assumed to be previously stored in storage unit 104 of image data forming apparatus 100.

FIGS. 7A and 7B are explanatory diagrams of an example of a screen of PC 120 on which authentication-print-program-applied image file 600 of FIG. 6A formed by image data forming apparatus 100 is executed according to the first embodiment.

When the control unit of PC 120 executes authentication print program 601 included in authentication-print-program-applied image file 600, authentication print program window 700 shown in FIG. 7A is displayed on the display means such as an LCD of PC 120.

Authentication print program window 700 includes: print button 701 used to perform an authentication print; and viewer unit 702 used to display image data 602 as a preview screen.

When print button 701 is clicked, authentication dialogue box 710 illustrated in FIG. 7B is displayed. Authentication dialogue box 710 includes: text box 711 used to input a user name; text box 712 used to input a password; authentication button 713 used to request an authentication print; and cancel button 714 used to cancel the authentication print.

Operation of the above configuration will be explained.

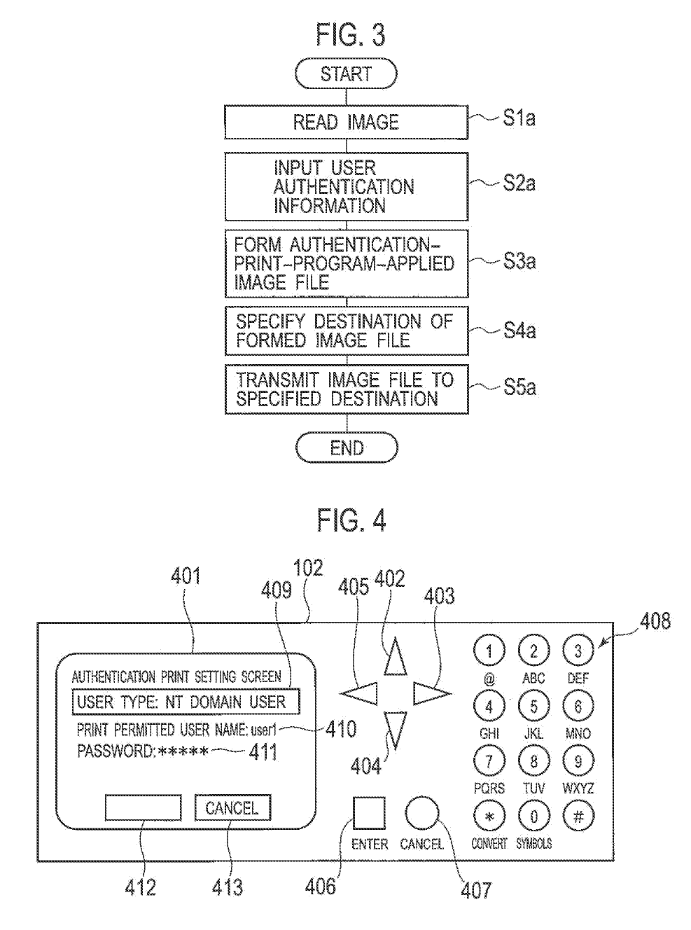

A process of forming an authentication-print-program-applied image file by image data forming apparatus 100 will be explained according to the steps represented by “S” in the flowchart of FIG. 3, which illustrates an image data forming process of the first embodiment, and with reference to FIG. 1.

S1a: According to an instruction from control unit 101, image data forming unit 105 of image data forming apparatus 100 scans (reads) an image and forms image data.

S2a: The operation panel unit 102 accepts an input of authentication information such as a user name and a password of a user who is to be allowed to print, and user authentication information forming unit 106 forms user authentication information based on the input user name, password, and the like. Note that the input process of the authentication information by the user will be described later.

S3a: Image file forming unit 107 forms an authentication-print-program-applied image file including image data formed by image data forming unit 105 and user authentication information formed by user authentication information forming unit 106.

S4a: Operation panel unit 102 accepts a user's input specifying one or more PCs 120 as destinations of the generated authentication-print-program-applied image file, that is, a user's input specifying a computer name of PC 120 as the destination, for example.

S5a: According to an instruction from control unit 101, communication control unit 108 transmits the authentication-print-program-applied image file to PC 120 that is the specified destination.

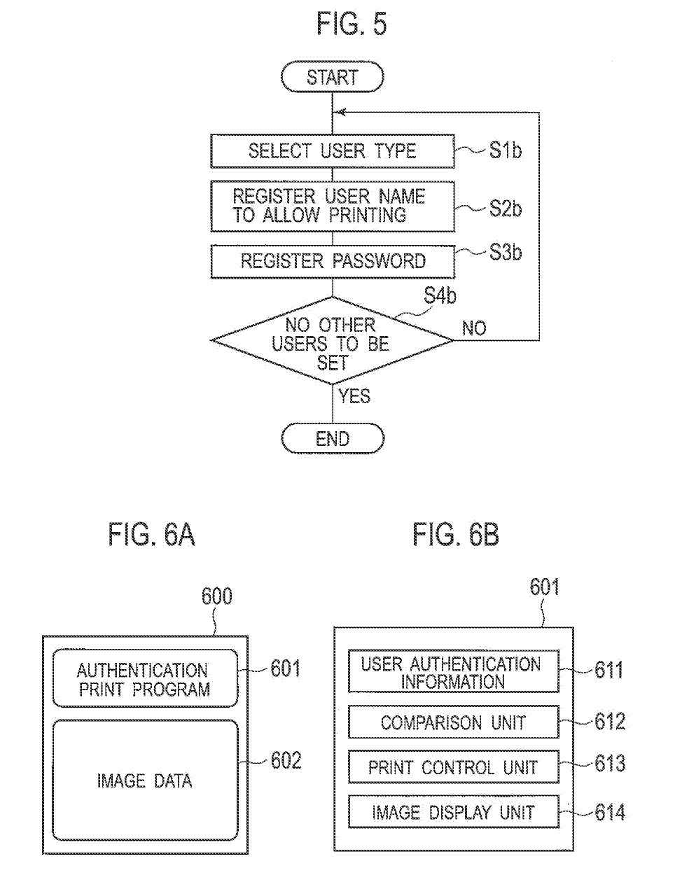

Next, the process of accepting input of authentication information of the user in step S2a of FIG. 3 will be explained according to the steps represented by “S” in the flowchart of FIG. 5, which illustrates the user authentication information input process of the first embodiment, and with referring to FIGS. 1 and 4.

A user inputs authentication information on operation panel unit 102 of image data forming apparatus 100 illustrated in FIG. 1. The authentication print setting screen illustrated in FIG. 4 is displayed on LCD display panel 401 of operation panel unit 102 to accept the input of the authentication information by the user.

S1b: According to an instruction from control unit 101, operation panel unit 102 first accepts the user's input of the user type in user type setting unit 409 of the authentication print setting screen shown on LCD display panel 401 by using operation units 402 to 405 and the like. Here, the user can be registered by selecting a directory service such as “NT domain” and “Active Directory” (registered trademarks) according to the user's network environment and obtaining the user name and password of the user to be allowed to print. It is assumed that, when such a network environment has not been created, “standard” is selected and a user name and a password are input.

S2b: The user who selects a directory service is assumed to select and input a user name, which is to be allowed to print, to user name registration unit 410 and operation panel unit 102 accepts the input operation via operation unit 408 or the like. Control unit 101 stores the input user name to memory unit 103. Here, the password is also stored with the user name to memory unit 103.

On the other hand, the user who selects “standard” is assumed to input a user name, which is allowed to print, to user name registration unit 410 and operation panel unit 102 accepts the input operation via operation unit 408 or the like. Control unit 101 stores the input user name to memory unit 103.

S3b: When “standard” is selected, operation panel unit 102 accepts a user's input of a password in password registration unit 411 by using operation unit 408 or the like. Control unit 101 stores the input password to memory unit 103 as associating with the user name which is selected and input in step S2b.

Note that, in a case where a directory service is selected, the process proceeds to step S4b, skipping step S3b.

S4b: Plural users can be set as print-allowed users. When there is no other users to set authentication information, operation panel unit 102 accepts a press of enter button 406 and ends the input operation of user authentication information. Here, when there is another user to set authentication information, operation panel unit 102 accepts a press of add button 412 and the process proceeds to step S1b and repeats from steps S1b to S3b.

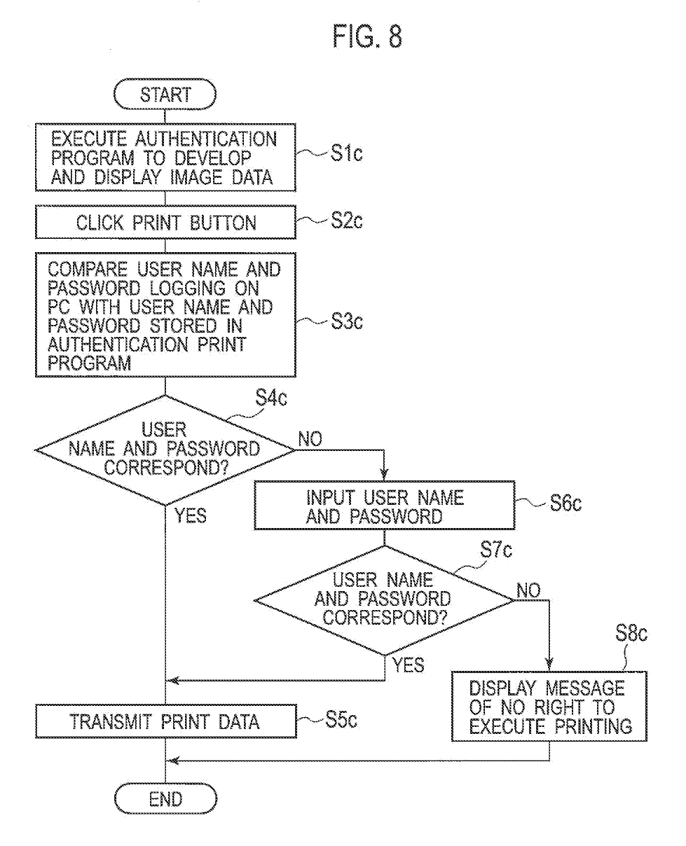

Next, the process of executing an authentication-print-program-applied image file in PC 120 will be explained according to the steps represented by “S” in the flowchart of FIG. 8, which illustrates a process of executing an authentication-print-program-applied image file of the first embodiment, and with reference to FIGS. 1, 2, 6A, 6B, 7A and 7B.

S1c: In order to print image data 602 of authentication-print-program-applied image file 600 that is formed and transmitted by image data forming apparatus 100 in FIG. 1 and has a configuration illustrated in FIG. 6A, PC 120 in FIG. 2 develops authentication-print-program-applied image file 600. In other words, when the control unit of PC 120 executes authentication print program 601 of authentication-print-program-applied image file 600, a screen of authentication print program window 700 illustrated in FIG. 7A is displayed on the display means by image display control unit 614 of authentication print program 601 of authentication-print-program-applied image file 600.

S2c: PC 120 accepts a click on print button 701 in a screen illustrated in FIG. 7A.

S3c: Upon the click on print button 701, PC 120 executes comparison unit 612 of authentication print program 601 of authentication-print-program-applied image file 600 to read, from memory unit 124, a name and password of a user who is logged on PC 120 as login information and compares the read user name and password with the user name and password of user authentication information 611 in authentication-print-program-applied image file 600 received from image data forming apparatus 100.

S4c: When PC 120 judges that the login information corresponds with user authentication information 611 as a result of comparing the login information and user authentication information 611, the process proceeds to step S5c. When PC 120 judges that the login information does not correspond with user authentication information 611, the process proceeds to step S6c.

S5c: When PC 120 judges that the login information corresponds with user authentication information 611, in order to print image data 602 of authentication-print-program-applied image file 600, PC 120 executes print control unit 613 of authentication-print-program-applied image file 600 to transmit image data 602 as print data to printing device 200 that is a specified printer, to cause printing device 200 to print image data 602, and end the process.

S6c: When PC 120 judges that the login information does not correspond with user authentication information 611, PC 120 displays authentication dialogue box 710 illustrated in FIG. 7B on the display means and accepts a user's input of a user name and a password by using the input means of PC 120 and stores the user name and password to memory unit 124 of PC 120.

S7c: PC 120 executes comparison unit 612 of authentication-print-program-applied image file 600 to read the input user name and password from memory unit 124 and compares the read user name and password with the user name and password which are stored as user authentication information 611 in authentication-print-program-applied image file 600 received from the image data forming apparatus 100.

When PC 120 judges that the read user name and password correspond with the user name and password of user authentication information 611, the process proceeds to step S5c. In order to print image data 602 of authentication-print-program-applied image file 600, PC 120 executes print control unit 613 of authentication-print-program-applied image file 600 to transmit image data 602 to printing device 200 that is the specified printer to cause printing device 200 to print image data 602 and then ends the process.

S8c: On the other hand, when PC 120 judges that the input user name and password do not correspond with the user name and password of user authentication information 611, PC 120 displays a message indicating that there is no authorization for printing on the display means and ends the process.

As described above, an image data forming apparatus transmits, to a personal computer, an authentication-print-program-applied image file including scanned image data and an authentication print program for identifying authentication information such as a user name and a password. When receiving the authentication print program, the personal computer performs an authentication process to allow printing of a qualified user, and transmits image data to a printing device for the qualified user. With this configuration, even when a printer management server which performs an authentication process is not connected to a communication line, a user who is not qualified to print with the printing device is restricted from printing.

In other words, the personal computer having received the authentication-print-program-applied image file from the image data forming apparatus can optionally display image data included in the authentication-print-program-applied image file; however, if a user is not authorized due to a restriction by the image data forming apparatus, the personal computer is restricted from outputting the image data included in the authentication-print-program-applied image file from the personal computer to the outside.

In this embodiment, an example in which image data is output to a printing device via a network has been described; however, a communication line such as a USB (universal serial bus) may be used as a substitute for the network. It is thus possible to restrict an output or a transfer to an external device such as a USB memory and a magnetic disk.

According to this embodiment, by a directory service such as “NT domain” and “Active Directory” (registered trademarks), a user name and a password used as authentication information in an authentication print program are automatically obtained as a user name and a password of a user who is allowed to print by a transmitter and used as authentication information, and that user name and password are authenticated by comparing the user name and password used when logging on PC 120 serving as a receiver. However, this does not limit the invention. A transmitter may manually set any password used as authentication information via operation panel unit 102 of image data forming apparatus 100, and the password may be used as authentication information in an authentication print program. In this case, printing may be allowed when a user as a receiver who knows the password and inputs the password to start printing.

Further, in this embodiment, an example in which an authentication print program is applied to the scanned image data has been described; however, this does not limit the invention and the authentication print program may be applied to image data that is input to the image data forming apparatus from an external device such as a USB memory or an external memory device, for example.

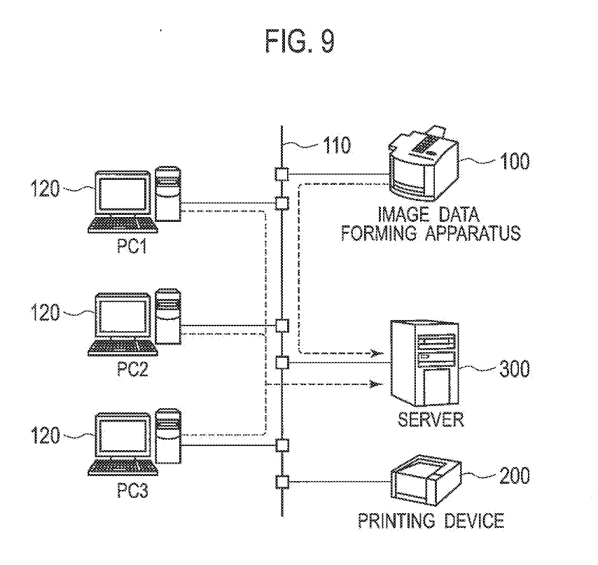

Furthermore, in this embodiment, an example in which an image file applied with an authentication print program is transmitted to PC 120 serving as a receiver has been described; however, this does not limit the invention, and, as shown in FIG. 9, an image file applied with an authentication print program that is formed in image data forming apparatus 100 by a transmitting user may be transmitted to and stored in shared storage terminal 300 such as a server and an authentication may be performed when plural users access from PCs 120 to start printing.

As described above, according to the first embodiment, the image data forming apparatus transmits, to a personal computer, an authentication-print-program-applied image file which is formed by applying, to read scanned image data, an authentication print program used to authenticate information such as a user name and a password, and the personal computer that receives and executes the authentication print program performs an authentication process to allow a qualified user to pint and transmit the image data to a printing device. With this configuration, even when a printer management server that executes an authentication process is not connected to the communication line, restricting printing by an unqualified user is possible.

Further, restricting output of image data by an unqualified user from the device can is possible.

### Second Embodiment

In the configuration of the second embodiment, a screen used to input print restriction information that restricts color printing and double-sided printing and a screen to notify a user of the input print restriction information are provided in addition to the configuration of the first embodiment. The configuration of the second embodiment will be explained with reference to FIGS. 11, 13A, 13B, 14A, 14B and 14C.

The configurations of the image data forming apparatus and PC and the configuration of the image data forming system are the same as those of the first embodiment illustrated in FIGS. 1 and 2, and those explanations are omitted. Other parts that are the same as the first embodiment will be designated by the same reference numerals and the explanations thereof will be omitted.

FIG. 11 is an explanatory diagram of operation panel unit 102 used to set user authentication information and print restriction information according to the second embodiment.

In FIG. 11, LCD display panel 401 displays an authentication print setting screen used to input user authentication information and print restriction information. The authentication print setting screen includes: a color print restriction unit 1001 used to set a color print restriction; and print side restriction unit 1002 used to set a print side restriction, in addition to user type setting unit 409, user name registration unit 410, password registration unit 411, add button 412, and cancel button 413 illustrated in FIG. 4 of the first embodiment.

FIGS. 13A and 13B are explanatory diagrams of an authentication-print-program-applied image file according to the second embodiment. FIG. 13A illustrates the configuration of an authentication-print-program-applied image file and FIG. 13B illustrates the configuration of an authentication print program.

As shown in FIG. 13A, as in the first embodiment, authentication-print-program-applied image file 600 formed by image data forming apparatus 100 includes authentication print program 601 and image data 602.

Authentication print program 601 is software executed by PC 120 and, as illustrated in FIG. 6B, includes, in addition to user authentication information 611, comparison unit 612, and image display control unit 614, for example: print restriction information 621 composed of a color print restriction and a print side restriction which are set via the authentication print setting screen; and print control unit 622 which is a program for controlling whether or not to print image data 602 according to a judgment result by comparison unit 612 of whether the user name and password input by a receiving user correspond to the user name and password of user authentication information 611 and according to previously set print restriction information 621.

Image data 602 is image data formed by image data forming unit 105 of image data forming apparatus 100. Further, comparison unit 612, print control unit 623, and image display control unit 614 are assumed to be previously stored in storage unit 104 of image data forming apparatus 100.

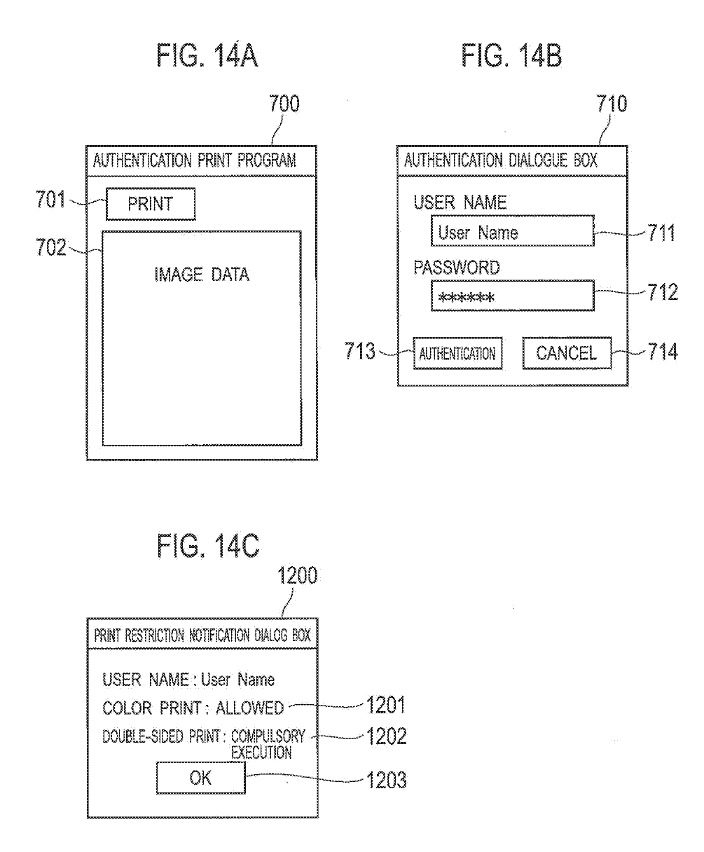

FIGS. 14A, 14B and 14C are explanatory diagrams of an example of executing an authentication-print-program-applied image file according to the second embodiment and illustrate a screen of PC 120 in a case where authentication-print-program-applied image file 600 formed by image data forming apparatus 100 is executed in PC 120.

Authentication print program window 700 illustrated in FIG. 14A and authentication dialogue box 710 illustrated in FIG. 14B are the same as those in the first embodiment and, in the second embodiment, print restriction notification dialog box 1200 that notifies a user of printing restriction illustrated in FIG. 14C is added.

Print restriction notification dialog box 1200 includes section 1201 that notifies a color print restriction condition and section 1202 that notifies a print side restriction condition.

Operation of the above configuration will be explained.

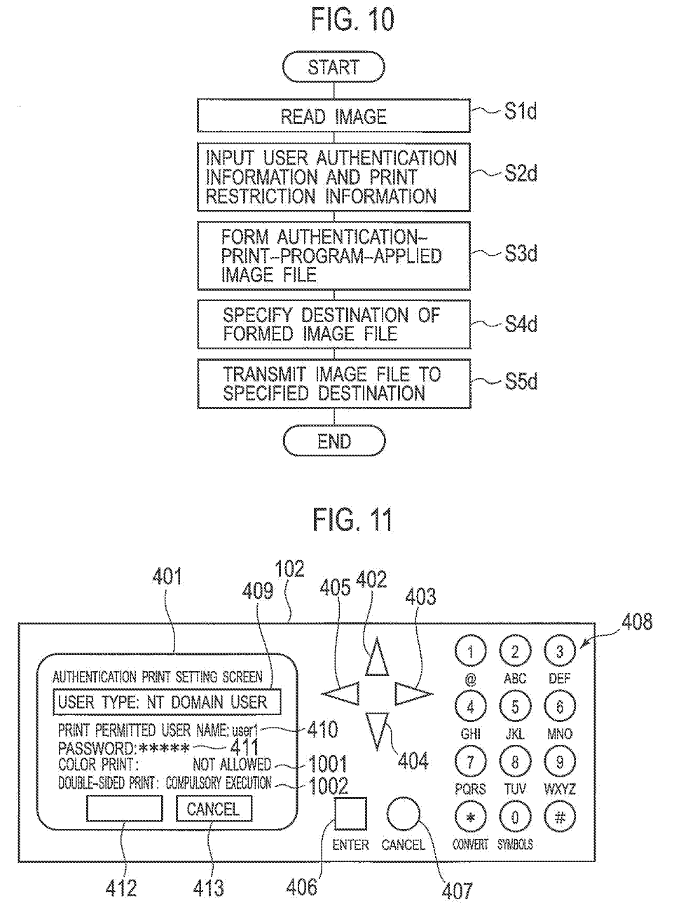

First, a process by which image data forming apparatus 100 creates an authentication-print-program-applied image file will be explained according to the steps represented by “S” in the flowchart of FIG. 10, which illustrates an image data forming process according to the second embodiment, and with referring to FIG. 1.

S1d: Image data forming unit 105 of image data forming apparatus 100 reads an image and forms image data according to an instruction from control unit 101.

S2d: Operation panel unit 102 accepts input of authentication information such as a user name and a password of a user who is to be allowed to print and print restriction information, and user authentication information forming unit 106 forms user authentication information based on the input user name and password. The process of inputting user authentication information and print restriction information will be described later.

S3d: Image file forming unit 107 forms an authentication-print-program-applied image file including image data formed by image data forming unit 105, user authentication information formed by user authentication information forming unit 106, and print restriction information set for each user.

S4d and S5d: The processes are the same as those in steps S4a and S5a of FIG. 3 and those explanations are omitted.

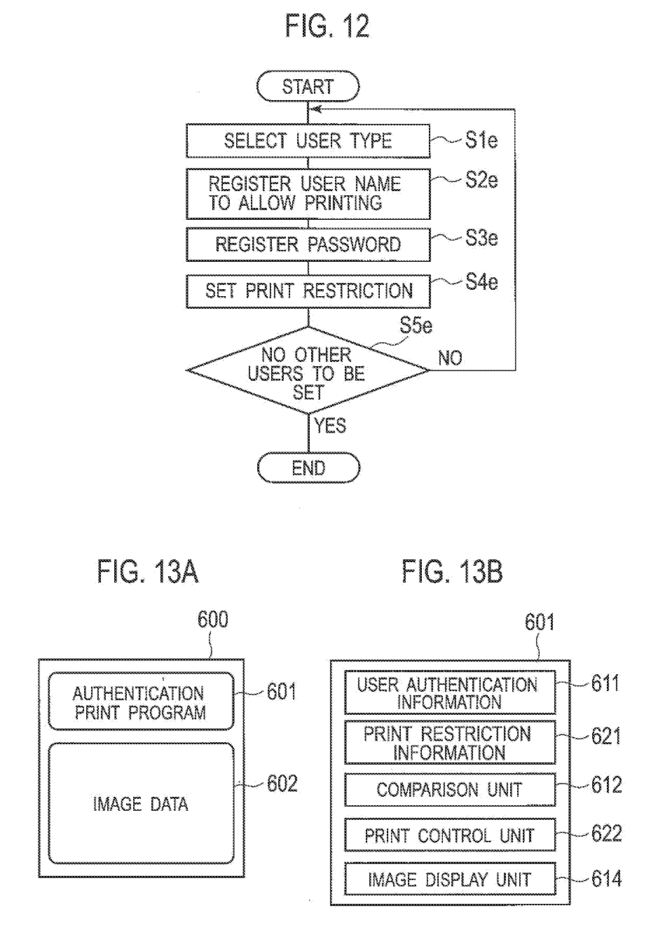

Next, the process of accepting input of user authentication information and print restriction information in step S2d of FIG. 10 will be explained according to the steps represented by “S” in the flowchart of FIG. 12, which illustrates a process of inputting user authentication information and print restriction information according to the second embodiment, and with reference to FIGS. 1 and 11.

This input of user authentication information is to be executed by operation panel unit 102 of image data forming apparatus 100 illustrated in FIG. 1. An authentication print setting screen illustrated in FIG. 11 is displayed on LCD display panel 401 of operation panel unit 102 to accept input of user authentication information and print restriction information.

S1e to S3e: The processes are the same as those in steps S1b to S3b of FIG. 5 and those explanations will be omitted.

S4e: According to an instruction from control unit 101, operation panel unit 102 accepts a user's input of whether or not to allow color printing by operation units 402 to 405 and the like via color print restriction unit 1001 of the authentication print setting screen displayed on LCD display panel 401 and accepts a user's input of whether or not to execute double-sided printing by operation units 402 to 405 and the like via print side restriction unit 1002 of the authentication print setting screen displayed on LCD display panel 401. Control unit 101 associates print setting information including the input color print setting and print side setting with a user name that is input in step Step and stored in memory unit 103.

S5e: Plural users may be set as users who are allowed to print and, when there is no other users to set authentication information and print restriction information, operation panel unit 102 accepts a press of enter button 406 and ends the input of user authentication information and print restriction information. Here, when there is another user to set authentication information and print restriction information, operation panel unit 102 accepts a press of add button 412, proceeds to a process in step S1e and repeats processes from steps S1e to S4e.

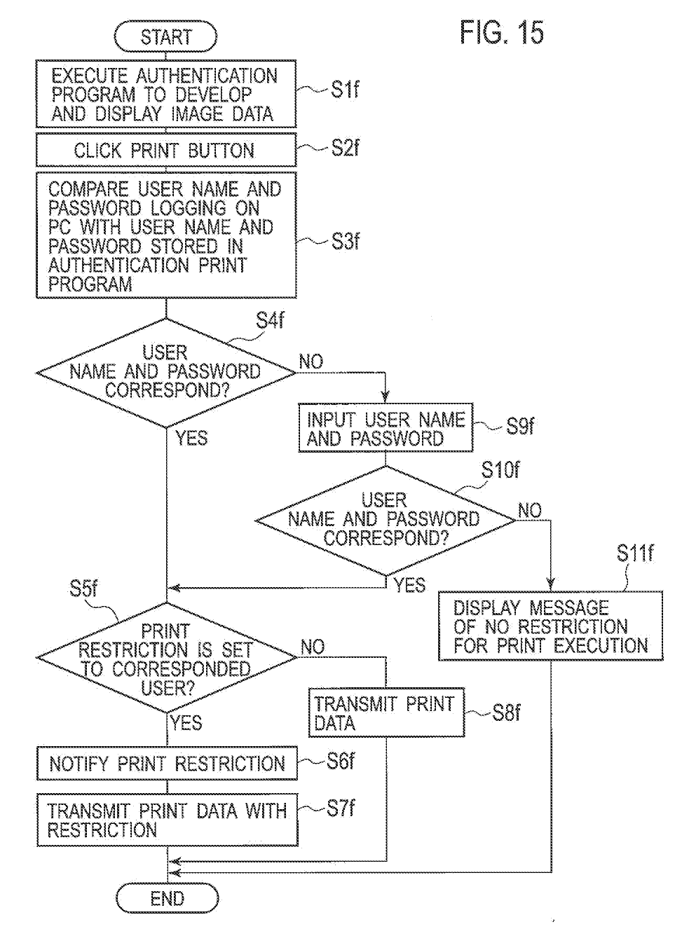

Next, the process in which PC 120 executes the authentication-print-program-applied image file will be explained according to the steps represented by “S” in the flowchart of FIG. 15, which illustrates a process of executing an authentication-print-program-applied image file according to the second embodiment, and with reference to FIGS. 1, 2, 13A, 13B, 14A, 14B and 14C.

S1f: In order to print image data 602 of authentication-print-program-applied image file 600, which is formed and transmitted by image data forming apparatus 100 illustrated in FIG. 1, and has a configuration illustrated in FIG. 13, image display control unit 614 of authentication-print-program-applied image file 600 displays the screen of authentication print program window 700 illustrated in FIG. 14A on the display means when PC 120 illustrated in FIG. 2 opens authentication-print-program-applied image file 600, that is, when the control unit of PC 120 executes authentication print program 601 of authentication-print-program-applied image file 600.

S2f: PC 120 accepts a click on print button 701 on the screen illustrated in FIG. 14A.

S3f: Upon accepting a click on print button 701, PC 120 executes comparison unit 612 of authentication-print-program-applied image file 600 to read the user name and password of a user who is logging onto PC 120 as login information from the memory unit 124 and compares the read user name and password with the user name and password of user authentication information 611 of authentication-print-program-applied image file 600 received from image data forming apparatus 100.

S4f When PC 120 judges that the login information corresponds with user authentication information 611 as a result of comparing the login information with the user authentication information 611, the process proceeds to step S5f. When PC 120 judges that the login information does not correspond with user authentication information 611, the process proceeds to step S9f.

S5f: When PC 120 judges that the login information corresponds with the user authentication information 611, PC 120 reads user authentication information 611 and print restriction information 621 and judges whether or not a print restriction is set by the user. When PC 120 judges that a print restriction is set, the process proceeds to step S6f. When PC 120 judges that a print restriction is not set, the process proceeds to S8f.

S6f: When PC 120 judges that a print restriction is set, PC 120 displays print restriction notification dialog box 1200 illustrated in FIG. 14C on the display means and notifies the user of the print restriction. The user is assumed to confirm the print restriction displayed on print restriction notification dialog box 1200 and to click operation confirmation button 1203.

S7f: When operation confirmation button 1203 displayed on print restriction notification dialog box 1200 is clicked, in order to print image data 602 of authentication-print-program-applied image file 600 based on set print restriction information 621, PC 120 executes print control unit 622 of authentication-print-program-applied image file 600 to transmit image data 602 together with information for restricting a color print and a print side as print data to printing device 200 serving as a specified printer. PC 120 causes printing device 200 to print image data 602 and ends the process.

S8f: On the other hand, when PC 120 judges that a print restriction is not set in step S5f, in order to print image data 602 of authentication-print-program-applied image file 600, PC 120 executes print control unit 622 of authentication-print-program-applied image file 600 to transmit image data 602 as print data to printing device 200 serving as a specified printer. PC 120 causes allows printing device 200 to print image data 602 and ends the process.

S9f: Further, when PC 120 judges that the login information does not correspond with user authentication information 611 in step S4f, PC 120 displays authentication dialogue box 710 illustrated in FIG. 14B on the display means, accepts an input of a user name and a password via the input means, and stores the user name and password in memory unit 124.

S10f; PC 120 executes comparison unit 612 of authentication-print-program-applied image file 600 to read the input user name and password from the memory unit 124 and compares the read user name and password with the user name and password of user authentication information 611 in authentication-print-program-applied image file 600 received from image data forming apparatus 100.

When PC 120 judges that the input user name and password correspond with the user name and password of user authentication information 611, the process proceeds to S5c and executes the above processes in steps S5f to S8f.

S11f; On the other hand, when PC 120 judges that the input user name and password do not correspond with the user name and password of user authentication information 611, PC 120 displays a message that the user does not have a right to execute printing on the display means and ends the process.

As described above, according to the second embodiment, in addition to the effect of the first embodiment, more sensitive print restrictions for a formed image file can be performed since print restriction information such as a color print restriction and a compulsory double-sided print is applied to the authentication-print-program-applied image file formed by image data forming apparatus.

In the first and second embodiments, an authentication print program is applied to image data read by a data reading function of the image data forming apparatus; however, the image data forming apparatus may be a facsimile or the like so that the authentication print program is applied to image data received from an external device. Further, the image data forming apparatus may be a multifunctional machine that has a function to transmit image data with communication means.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

What is claimed is:

1. An image data forming apparatus comprising:
an image data forming unit configured to form image data;
a user authentication information forming unit configured to form user authentication information;
a storage unit storing a program configured to be executed by a destination device to determine whether or not to permit outputting the image data from the destination device based on the user authentication information;
an image file forming unit configured to form an image file including the image data, the user authentication information, and the program; and
a communication control unit configured to transmit the image file to the destination device.

2. The image data forming apparatus according to claim 1, wherein
the user authentication information includes a user name to identify a user and a password previously set by the user; and
the program includes a comparison unit configured to compare an input user name and an input password, input into the destination device, with the user name and password of the user authentication information, to permit outputting the image data when the input user name and input password correspond with the user name and password of the user authentication information.

3. The image data forming apparatus according to claim 2, wherein
the input user name and the input password are input into the destination device during log in to the destination device.

4. The image data forming apparatus according to claim 1, wherein
the determination whether or not to permit outputting of the image data is a determination whether or not to permit printing of the image data.

5. The image data forming apparatus according to claim 4, wherein
the program includes print restriction information of the image data that is output according to the determination whether or not to permit printing.

6. The image data forming apparatus according to claim 5, wherein
the program is configured to be executed by the destination device to display the print restriction information.

7. The image data forming apparatus according to claim 1, wherein
the determination whether or not to permit outputting of the image data is a determination whether or not to permit transferring the image data toan external memory device.

8. The image data forming apparatus according to claim 7, wherein
the external memory device is a USB memory (Universal Serial Bus Memory).

9. The image data forming apparatus according to claim 1, wherein
the program includes an image display control unit configured to be executed by the destination device to display a preview of the image data without an authentication.

10. The image data forming apparatus according to claim 1, wherein
the communication control unit transmits the image file to plural destination devices.

11. The image data forming apparatus according to claim 1, wherein
the communication control unit transmits the image file to a shared storage terminal.

12. The image data forming apparatus according to claim 1 is a facsimile device.

13. The image data forming apparatus according to claim 1 is a multi-function peripheral.

14. An image processing method comprising steps of
forming image data;
forming user authentication information;
forming an image file including the image data, the user authentication information, and a program, the program being configured to be executed by a destination device to determine whether or not to permit outputting of the image data from the destination device based on the user authentication information; and
transmitting the image file to the destination device.
